(19) United States
(12) Patent Application Publication
(10) Pub. No.: US 2005/0236228 A1
(43) Pub. Date: Oct. 27, 2005

(54) Ladder support system

(76) Inventor: Marcel Thibault, Mont St-Hilaire (CA)

Correspondence Address: Eric Fincham, 316 Knowlton Road, Lac Brome, QC, J0E 1V0, CA

(21) Appl. No.: 11/040,583

(22) Filed: Jan. 20, 2005

(30) Foreign Application Priority Data
Jan. 21, 2004 (CA) 2,455,535

(51) Int. Cl. E06C 5/32

(52) U.S. Cl. 182/127

(57) ABSTRACT

A ladder support assembly suitable for supporting a ladder on a side of a vehicle, the ladder support assembly having first and second frame portions with the second frame portion being secured to the side of the vehicle, the first frame portion being hingedly connected to the second frame portion, the first frame portion having a plurality of ladder supports thereon, the first frame portion being removable between a first opened position whereby access may be had to the ladder in a second closed position wherein the ladder is retained between the first and second frame portions.

### FIELD OF THE INVENTION

The present invention relates to a ladder support assembly and more particularly, relates to a ladder support assembly, suitable for attachment to a vehicle.

### BACKGROUND OF THE INVENTION

Many vehicles and in particular, service vehicles are required to carry a ladder. For example, the different utilities including the electric utility company, the telephone company, the gas company, cable and television companies and the like require that their service vehicles carry ladders for gaining access to their various facilities which are frequently mounted on poles. For many years, the ladders were carried on the top of the vehicles since this was considered the most practical option. However, as vehicles have become higher and with the increasing weight of some ladders, it becomes extremely difficult to reach and remove the ladders from the vehicle top.

In order to overcome this problem, more and more companies are storing the ladder on the side of the vehicle. By so doing, the ladder remains accessible. Typically, the ladder has been stored on the side of the vehicle with two or more hook like members on which the ladders are placed. Various types of securement systems to lock the ladders in place are provided. While such arrangement accomplishes the desired purpose, it is very basic and does not fulfil the requirements of many companies.

One problem associated with the storage of ladders on the side of the vehicle is that the ladders should generally be secured at a height which is usually higher than the height of the average employee. Accordingly, it becomes necessary to reach over ones head to remove or replace the ladder. This is both an awkward and dangerous proposition for many employees. The reason for the higher placement of the ladder relates to both safety concerns and for aesthetic reasons.

### SUMMARY OF THE INVENTION

It is an object of the present invention to provide a ladder support assembly which may be mounted on the side of the vehicle, can be readily accessed, and overcomes many of the problems associated with known ladder support assemblies.

According to one embodiment of the present invention, there is provided a ladder support assembly comprising a first frame portion, a second frame portion, means for securing the second frame portion to a substrate, the second frame portion being hingedly connected to the first frame portion, means on one of the first and second frame portions for receiving and retaining a ladder, the first frame portion being moveable between a first opened position whereby access maybe had to the ladder and a second closed position wherein the ladder is retained between the first and second frame portions.

As above mentioned, the ladder assembly of the present invention includes a first frame portion and a second frame portion, and which frame portions are hingedly connected together. At least one of the frame portions includes a ladder support means for supporting the ladder when in a storage position. While the ladder support means could be on either the first frame portion or the second frame portion, preferably it is on the first frame portion—i.e. that which is lowered during operation of the assembly. In so doing, the ladder remains more accessible to the employee.

The ladder support assembly further includes a power assist means to aid in the lifting of the first frame portion and also to slow the descent of the first frame portion when access to the ladder is required. The power assist means may include one or more pneumatic or hydraulic cylinder or the like. It would also be within the scope of the present invention to utilize a spring arrangement. Thus, one could use a combination of spring and/or cylinders to assist in both raising and lowering the first frame portion.

The second frame portion, in the preferred embodiment, is secured to the side of a vehicle. Typically, such a vehicle will be a truck or van and any suitable means for securing the second frame portion thereto may be employed.

The ladder support assembly will include, as aforementioned, means on one of the first or second frame portions for retaining a ladder. Typically, such a means for retaining would comprise a bracket extending outwardly. In the preferred embodiment, the ladder support means is mounted on the first frame portion such that when it is lowered, the ladder is at a lower position.

The apparatus will also include means for preventing movement of the ladder when the vehicle is in motion as it will be described in the preferred embodiments herein.

The ladder support assembly preferably is formed of a metallic material although it will be understood that plastic materials may equally well be employed.

When the first frame portion is lowered, the power assist means is put in a state of compression (when the hydraulic or pneumatic cylinder is utilized). Subsequently, this is available for a power assist when moving the first frame portion upwardly to a storage position.

### BRIEF DESCRIPTION OF THE DRAWINGS

Having thus generally described the invention, reference will be made to the accompanying drawings illustrating an embodiment thereof, in which:

FIG. 1 is a perspective view of a ladder support assembly, according to one embodiment of the present invention, when in a closed position and with a ladder being shown in dotted lines;

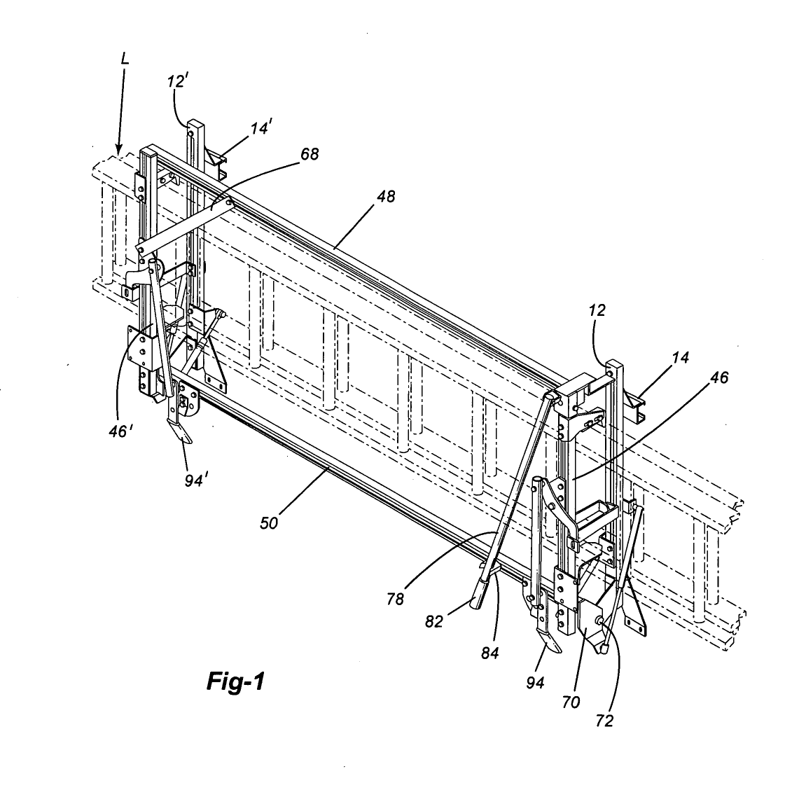

FIG. 2 is a perspective view of the ladder support assembly when in an opened position;

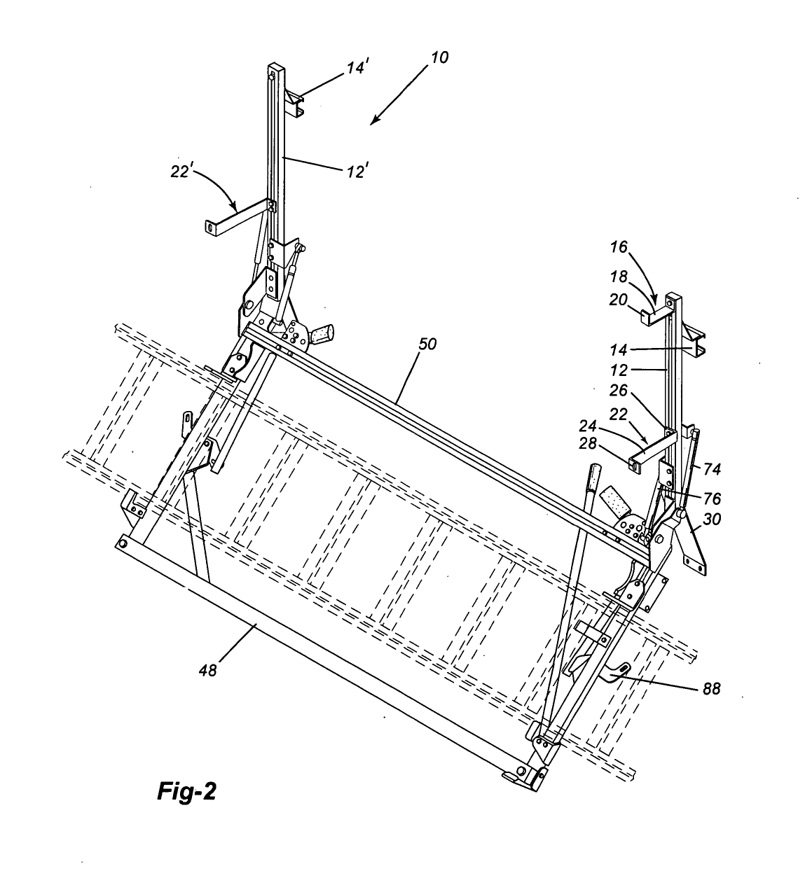

FIG. 3 is a perspective view of the ladder support assembly in a closed position;

FIG. 4 is a front elevational view of the ladder support assembly;

FIG. 5 is an end elevational view thereof; and

FIG. 6 is an end elevational view illustrating the opening and closing of the ladder support assembly.

### DESCRIPTION OF THE PREFERRED EMBODIMENTS

Referring to the drawings in greater detail and by reference characters thereto, there is illustrated a ladder support assembly which is generally designated by reference numeral 8.

Ladder support assembly 8 includes a first frame portion 44 and a second frame portion 10.

Second frame portion 10 is comprised of a pair of vertical mounting rails 12, 12′ each having, at an upper end thereof, a mounting bracket 14, 14′ for securing the second frame portion to a substrate. Typically, the substrate would be the side of a vehicle although naturally, other substrates such as walls and the like, may be utilized. Any suitable type of mounting bracket can be employed.

An L-shaped bracket 16 extends outwardly from rail 12 and has a main portion 18 with an end flange 20.

Situated below bracket 16 is a second bracket 22 which has a central portion 24, a first end portion 26 secured to vertical mounting rail 12, and a second end flange portion 28. A like bracket 22′ is provided for vertical mounting rail 12′. Also secured to vertical mounting rails 12, 12′ are mounting plates 30, 30′ for securement to a substrate.

Also secured to vertical mounting rails 12, 12′ are L-shaped brackets 32, 32′ for reasons which will be discussed herein below. Similarly, interconnecting elements 34, 34′ are mounted on vertical mounting rails 12, 12′ for interconnecting the first and second frame portions as it will be discussed in greater detail hereinbelow. Rear mounting bracket 36 is connected to the back of vertical mounting rail 12. A like rear mounting bracket (not shown) is also associated with vertical mounting rail 12′.

First frame portion 44 is comprised of a pair of vertical rails 46, 46′ which are interconnected at the upper end by an upper horizontal rail 48 and at the lower end by a lower horizontal end 50.

Mounted on vertical rails 46, 46′ are upper brackets 52, 52′ respectively. As will be seen, secured to brackets 52, 52′ are retaining members 58, 58′, the retaining members being secured by bolts 60, 60′.

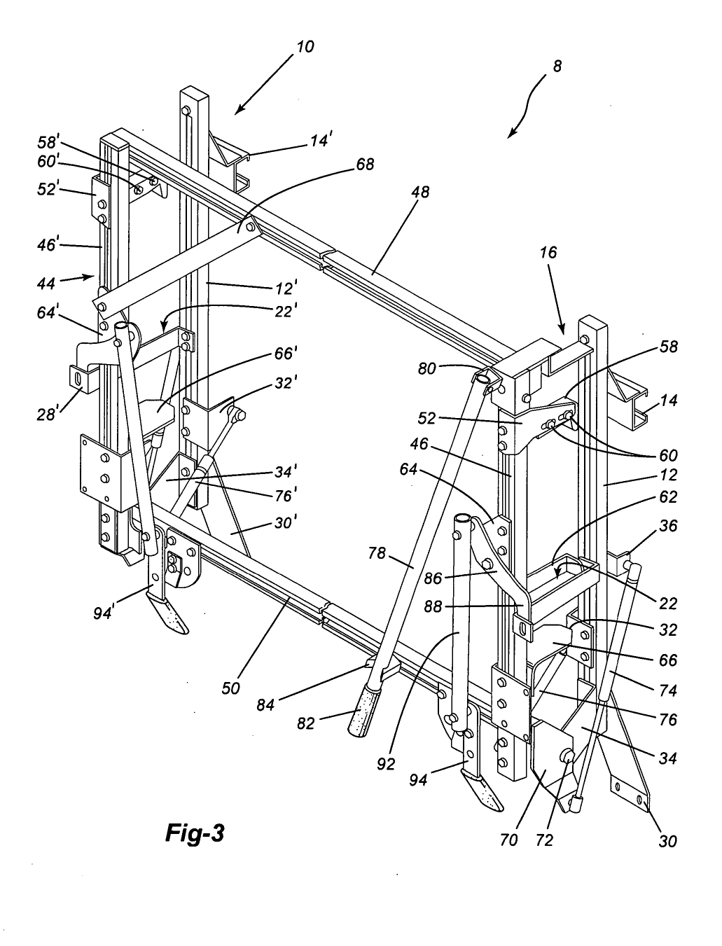

As may be seen in FIG. 3, there is also supplied a lower bracket 62, which is secured to vertical rail 46. Also secured to vertical rails 46, 46′ are ladder support members 66, 66′.

Situated at the lower portion of vertical rail 46, 46′ are interconnecting elements 70 which, as may seen, are secured to respective interconnecting elements 34, 34′ by means of a pivot bolt 72.

Power assist means are provided by means of a first hydraulic cylinder 74 extending between bracket 36 and a lower portion of second interconnecting element 70 and a second hydraulic cylinder 76 having one end secured to bracket 32 and interconnecting element 70. Cylinders 74′, 76′ are supplied on the other side.

As seen in FIG. 3, a reinforcing bar 68 may extend between upper horizontal rail 48 and vertical rail 46′.

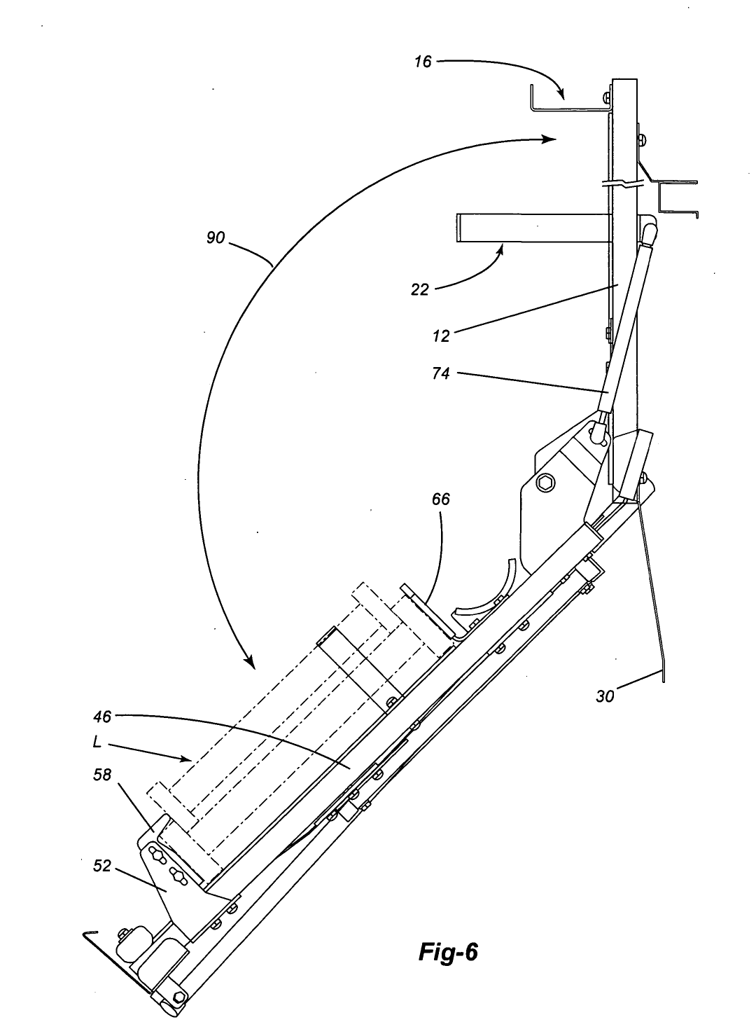

To assist in moving the first frame portion into and out of a ladder retaining position, there is provided a rod 78 which is connected to a bracket 80 secured to the top of vertical rail 46. At its distal end, rod 78 is provided with a handle portion 82 with the rod being held by a bracket 84 on lower horizontal rail 50. In operation, first frame portion 44 may be lowered to an opened position by removing rod 78 from bracket 84 and pulling on the same. The first frame portion will then lower as indicated by arrow 90 in FIG. 6. The ladder L may then be placed and held on first frame portion 44 by means of ladder support means 66, 66′ and retaining members 58, 58′. The ladder is secured so that one of the steps is retained between brackets 22 and 62 to prevent sliding movement of the ladder.

Subsequently, the assembly may easily be lifted upwardly with assistance from hydraulic cylinders 74, 74′, 76, 76′.

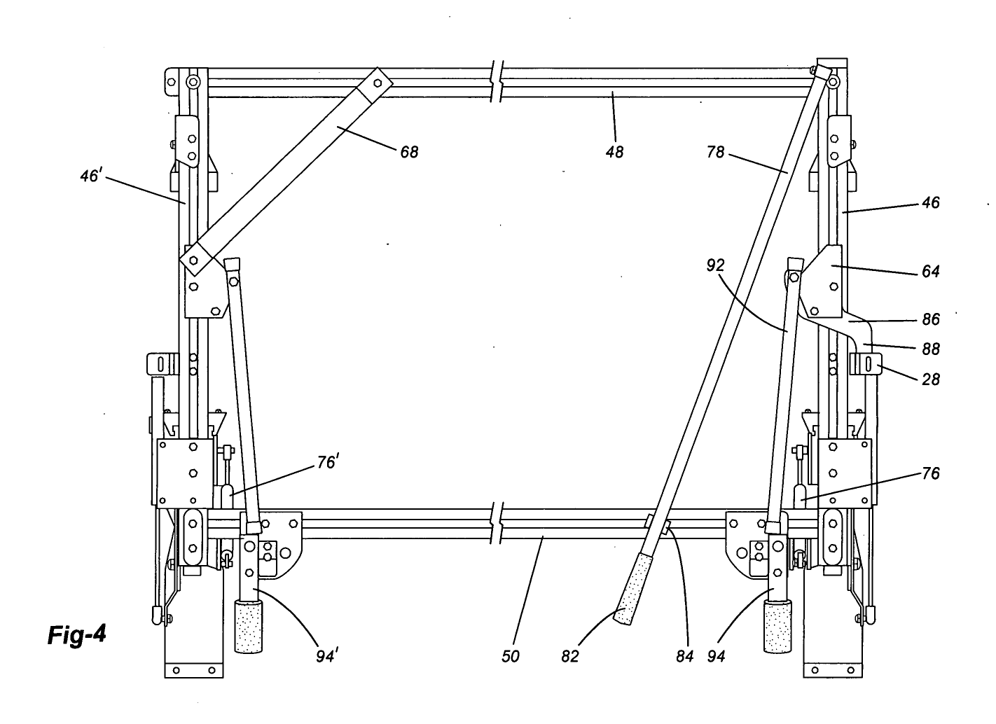

In order to retain the first frame portion 44 in a closed position, there is provided a locking assembly which comprises a first member 86 pivotally connected to bracket 64. Member 86 includes a hook portion 88 at one end thereof. At the other end, member 86 is pivotally connected to rod 92. A handle portion 94 is connected to the frame and pivotally connected to the other end of rod 92. Thus, hook portion 88 is designed to engage bracket 22 as may be seen in FIGS. 3 and 4.

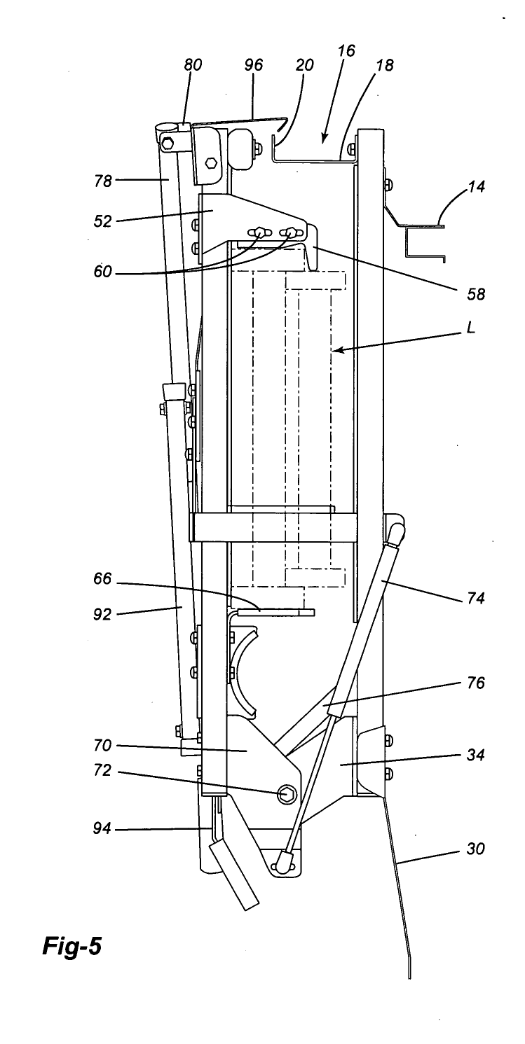

At its upper extremity, vertical rail 46 may be provided with a hook shaped portion 96 as seen in FIG. 5.

In order to secure the locking assembly in a locked position, a lock or other similar device may be used to secure handle 94 in a locked position.

It will be understood that the above described embodiments are for purposes of illustration only and the changes and modifications may be made thereto without departing from the spirit and scope of the invention.

1. A ladder support assembly comprising:
a first frame portion;
a second frame portion;
means for securing said second frame portion to a substrate;
said second frame portion being hingedly connected to said first frame portion;
means on one of said first and second frame portions for receiving and retaining a ladder;
said first frame portion being moveable between a first opened position whereby access may be had to said ladder and a second closed position wherein said ladder is retained between said first and second frame portions.

2. The ladder support assembly of claim 1 wherein said first frame portion and said second frame portion are pivotally connected together.

3. The ladder support assembly of claim 2 wherein said means for receiving and retaining a ladder comprises retaining members mounted on said first frame portion.

4. The ladder support assembly of claim 2 further including locking means for locking said first frame portion and said second frame portion together when in said second closed position.

5. The ladder support assembly of claim 4 further including a handle attached to said first frame portion, said handle comprising an elongated rod.

6. The ladder support assembly of claim 2 further including power assist means operative to assist in moving said first frame portion from said second closed position to said first opened position and to control and slow movement of said first frame portion when moving from said closed position to said opened position.

7. The ladder support assembly of claim 6 wherein said power assist means comprises first and second cylinders selected from hydraulic cylinders and pneumatic cylinders.
